(19) United States
(12) Patent Application Publication
(10) Pub. No.: US 2008/0219741 A1
(43) Pub. Date: Sep. 11, 2008

(54) TAPE DRIVE

(76) Inventors: Martin McNestry, Derbyshire (GB); Keith Buxton, Nottingham (GB); George Borkey Yundt, Andover, MA (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 12/043,204

(22) Filed: Mar. 6, 2008

Related U.S. Application Data
(60) Provisional application No. 60/894,514, filed on Mar. 13, 2007.

(30) Foreign Application Priority Data
Mar. 7, 2007 (GB) 0704369.8

(51) Int. Cl. B41J 33/02

(52) U.S. Cl. 400/234

(57) ABSTRACT

A tape drive comprising first and second motors, two tape spool supports on which spools of tape may be mounted, each spool being drivable by a respective one of said motors, a sensor for sensing tape motion between the spools, and a controller. The controller is adapted to receive a first signal indicating demanded tape motion, provide a first control signal to at least one of the motors, the first control signal being based upon said demanded tape motion and being configured to cause tape to be transported between spools mounted on the spool supports, receive a second signal from said sensor indicating actual tape motion in response to said first control signal, and provide a second control signal to at least one of the motors, the second control signal being based upon said first and second signals.

### CROSS-REFERENCE TO RELATED APPLICATIONS

This application claims priority to and is based on United Kingdom Application No. 0704369.8 filed Mar. 7, 2007, and incorporated herein by reference in its entirety.

In addition, this application claims priority to and is based on U.S. Provisional Application No. 60/894,514 filed Mar. 13, 2007, and incorporated herein by reference in its entirety.

### BACKGROUND OF THE INVENTION

The present invention relates to a tape drive. Such a tape drive may form part of printing apparatus. In particular, such a tape drive may be used in transfer printers, that is, printers which make use of carrier-supported inks.

In transfer printers, a tape which is normally referred to as a printer tape and carries ink on one side is presented within a printer such that a printhead can contact the other side of the tape to cause the ink to be transferred from the tape on to a target substrate of, for example, paper or a flexible film. Such printers are used in many applications. Industrial printing applications include thermal transfer label printers and thermal transfer coders which print directly on to a substrate such as packaging materials manufactured from flexible film or card.

Ink tape is normally delivered to the end user in the form of a roll wound onto a core. The end user pushes the core on to a tape spool, pulls a free end of the roll to release a length of tape, and then engages the end of the tape with a further spool. The spools may be mounted on a cassette, which can be readily mounted on a printing machine. The printing machine includes a transport means for driving the spools, so as to unwind tape from one spool and to take up tape on the other spool. The printing apparatus transports tape between the two spools along a predetermined path past the printhead.

Known printers of the above type rely upon a wide range of different approaches to the problem of how to drive the tape spools. Some rely upon stepper motors operating in a position control mode to pay out or take-up a predetermined quantity of tape. Other known printers rely on DC motors operating in a torque mode to provide tension in the tape and to directly or indirectly drive the spools. Some known arrangements drive only the spool on to which tape is taken up (the take-up spool) and rely upon some form of “slipping clutch” arrangement on the spool from which tape is drawn (the supply spool) to provide a resistive drag force so as to ensure that the tape is maintained in tension during the printing and tape winding processes and to prevent tape overrun when the tape is brought to rest. It will be appreciated that maintaining adequate tension is an essential requirement for the proper functioning of the printer.

Alternative forms of known printer tape drives drive both the take-up spool and the supply spool. A supply spool motor may be arranged to apply a predetermined drag to the tape, by being driven in the reverse direction to the direction of tape transport. In such an arrangement (referred to herein as “pull-drag”), the motor connected to the take-up spool is arranged to apply a greater force to the tape than the motor connected to the supply spool such that the supply spool motor is overpowered and the supply spool thus rotates in the direction of tape transport. The supply spool drag motor keeps the tape tensioned in normal operation.

In a further alternative arrangement a supply spool motor may be driven in the direction of tape transport such that it contributes to driving the tape from the supply spool to the take-up spool. Such an arrangement is referred to herein as “push-pull”. The take-up motor pulls the tape onto the take-up spool as the tape is unwound by the supply spool motor such that tape tension is maintained. Such a push-pull arrangement is described in our earlier UK Patent No. GB 2,369,602, which discloses the use of a pair of stepper motors to drive the supply spool and the take-up spool. In GB 2,369,602 a controller is arranged to control the energisation of the motors such that the tape may be transported in both directions between spools of tape. The tension in the tape being transported between spools is monitored and the motors are controlled to energise both motors to drive the spools of tape in the direction of tape transport.

As a printer gradually uses a roll of tape, the outer diameter of the supply spool decreases and the outer diameter of the take-up spool increases. In slipping clutch arrangements, which offer an essentially constant resistive torque, the tape tension will vary in proportion to the diameter of the spools. Given that it is desirable to use large supply spools so as to minimise the number of times that a tape roll has to be replenished, this is a serious problem particularly in high-speed machines where rapid tape transport is essential. For tape drives that use both a take-up motor and a supply spool motor, the variation in spool diameters can make it difficult to determine the correct drive signal to be supplied to each motor such that tape tension is maintained, and/or that tape is unwound or rewound at the correct rate.

Given these constraints, known printer designs offer a compromise in performance by way of limiting the rate of acceleration, the rate of deceleration, and the maximum speed capability of the tape transport system. Overall printer performance has, as a result, been compromised in some cases.

Known tape drive systems generally operate in one of two manners, that is either continuous printing or intermittent printing. In both modes of operation, the apparatus performs a regularly repeated series of printing cycles, each cycle including a printing phase during which ink is being transferred to a substrate, and a further non-printing phase during which the apparatus is prepared for the printing phase of the next cycle.

In continuous printing, during the printing phase a stationary printhead is brought into contact with a printer tape the other side of which is in contact with a substrate on to which an image is to be printed. The term “stationary” is used in the context of continuous printing to indicate that although the printhead will be moved into and out of contact with the tape, it will not move relative to the tape path in the direction in which tape is advanced along that path. During printing, both the substrate and tape are transported past the printhead, generally but not necessarily at the same speed.

Generally only relatively small lengths of the substrate which is transported past the printhead are to be printed upon, and therefore to avoid gross wastage of tape it is necessary to reverse the direction of travel of the tape between printing operations. Thus in a typical printing process in which the substrate is travelling at a constant velocity, the printhead is extended into contact with the tape only when the printhead is adjacent to regions of the substrate to be printed. Immediately before extension of the printhead, the tape must be accelerated up to, for example, the speed of travel of the substrate. The tape speed must then be maintained at the constant speed of the substrate during the printing phase and, after the printing phase has been completed, the tape must be decelerated and then driven in the reverse direction so that the used region of the tape is on the upstream side of the printhead.

As the next region of the substrate to be printed approaches, the tape must then be accelerated back up to the normal printing speed and the tape must be positioned so that an unused portion of the tape close to the previously used region of the tape is located between the printhead and the substrate when the printhead is advanced to the printing position. Thus very rapid acceleration and deceleration of the tape in both directions is required, and the tape drive system must be capable of accurately locating the tape so as to avoid a printing operation being conducted when a previously used portion of the tape is interposed between the printhead and the substrate.

In intermittent printing, a substrate is advanced past a printhead in a stepwise manner such that during the printing phase of each cycle the substrate and generally but not necessarily the tape, are stationary. Relative movement between the substrate, tape and printhead are achieved by displacing the printhead relative to the substrate and tape. Between the printing phase of successive cycles, the substrate is advanced so as to present the next region to be printed beneath the printhead, and the tape is advanced so that an unused section of tape is located between the printhead and the substrate. Once again rapid and accurate transport of the tape is necessary to ensure that unused tape is always located between the substrate and printhead at a time that the printhead is advanced to conduct a printing operation.

GB 2,298,821 describes a tape drive including a take-up spool driven by a stepper motor. Between a supply spool and the take-up spool tape passes around an idler roller having an anti-slip coating. The outer diameter of the idler roller is known. Rotation of the idler roller is monitored to determine an amount of ribbon movement for a particular number of steps through which the stepper motor was driven to achieve that movement. In subsequent printing operations, the number of steps through which the stepper motor is driven is modified based upon the determined amount of ribbon movement.

The requirements of high speed transfer printers in terms of tape acceleration, deceleration, speed and positional accuracy are such that many known drive mechanisms have difficulty delivering acceptable performance with a high degree of reliability. Similar constraints also apply in applications other than high-speed printers, for instance drives used in labelling machines, which are adapted to apply labels detached from a label web. Tape drives in accordance with embodiments of the present invention are suitable for use in labelling machines in which labels are detached from a continuous label web which is transported between a supply spool and a take-up spool.

### BRIEF DESCRIPTION OF THE INVENTION

It is an object of embodiments of the present invention to obviate or mitigate one or more of the problems associated with the prior art, whether identified herein or elsewhere. It is a further object of embodiments of the present invention to provide a tape drive which can be used to deliver printer tape in a manner which is capable of meeting the requirements of high speed production lines, although the tape drive of the present invention may of course be used in any other application where similar high performance requirements are demanded.

According to a first aspect of the present invention, there is provided a tape drive comprising first and second motors, two tape spool supports on which spools of tape may be mounted, each spool being drivable by a respective one of said motors, a sensor for sensing tape motion between the spools, and a controller. The controller is adapted to receive a first signal indicating demanded tape motion; provide a first control signal to at least one of the motors, the first control signal being based upon said demanded tape motion and being configured to cause tape to be transported between spools mounted on the spool supports; receive a second signal from said sensor indicating actual tape motion in response to said first control signal; and provide a second control signal to at least one of the motors, the second control signal being based upon said first and second signals.

Thus, a sensor sensing actual tape displacement is used to provide a feedback signal which is used to drive at least one of the motors. In this way, a system in which at least one of the motors is driven to achieve the demanded tape displacement is provided. The feedback is preferably used by the controller substantially in real time.

The tape drive may be configured to carry out a plurality of tape movement operations, each operation having at least one associated demanded tape displacement. For each operation the controller may be adapted to receive a plurality of second signals, each second signal indicative of a tape displacement during that operation.

It can thus be appreciated that sensor response speed is of considerable importance. Indeed, in a single tape movement operation in a printing apparatus a plurality of sensor measurements may be provided and processed.

The sensor may be configured to monitor tape motion in a variety of ways. For example, tape displacement or tape velocity may be monitored. The sensor is preferably a non-contact sensor. The first control signal may be further based upon an initial signal received from said sensor.

It is preferred that each spool support is coupled to a respective motor by means of a drive coupling providing at least one fixed transmission ratio. Preferably, the ratio of angular velocities of each motor and its respective spool support is fixed. Such an arrangement requires that control of a motor to cause a desired linear tape movement from or to a respective spool takes into account the circumference of that spool.

The drive coupling may comprise a drive belt. Alternatively, as each spool support has a respective first axis of rotation and each motor has a shaft with a respective second axis of rotation, the respective first and second axes may be coaxial. Respective drive couplings may interconnect a respective spool shaft to a respective motor shaft.

The motors may take any convenient form. For example, at least one of the first and second motors may be a torque-controlled motor. At least one of the first and second motors may be a position-controlled motor. The or each position-controlled motor may be a stepper motor.

The controller may be adapted to provide said control signals to said first motor and said second motor.

The tape drive may further comprise a second sensor arranged to provide a third signal to the controller indicative of actual tape displacement. The controller may be configured to use the third signal to generate a third control signal and to provide said third control signal to at least one of said motors.

The controller is preferably arranged to control the motors to transport tape in both directions between the spools.

The or each sensor preferably comprises an optical sensor arranged to capture and compare images of the tape at a position between the spools at predetermined intervals and to detect movement of the tape between the spools. Indeed in general terms any sensor capturing electromagnetic radiation reflected from the tape may be used.

The or each sensor may alternatively comprise a roller and means for sensing rotation of the roller, the roller being arranged to contact the tape between the spools such that linear movement of the tape causes the roller to rotate.

The controller may be operative to monitor tension in the tape being transported between the spools. The controller may be operative to control the motors to maintain tension to within predetermined limits.

According to a second aspect of the present invention, there is provided a tape drive comprising first and second motors, the first motor being a torque-controlled motor, two tape spool supports on which spools of tape may be mounted, each spool being drivable by a respective one of said motors, a controller for controlling the tenderisation of the motors such that the tape may be transported in at least one direction between spools mounted on the spool supports, and a sensor arranged to provide a position signal to the controller indicative of movement of the tape between the spools, wherein the controller is operative to receive an input signal indicative of a demanded tape displacement and to use the position signal to provide a control signal to the first motor to control the first motor based on the demanded tape displacement.

Features described above with reference to the first aspect of the invention may similarly be used in a tape drive in accordance with the second aspect of the invention.

A tape drive in accordance with certain embodiments of the present invention relies upon both the motors that drive the two tape spools to drive the tape during tape transport. Thus the two motors operate in push-pull mode. This makes it possible to achieve very high rates of acceleration and deceleration. Tension in the tape being transported is determined by control of the drive motors and therefore is not dependent upon any components that have to contact the tape between the take-up and supply spools. Thus a very simple overall mechanical assembly can be achieved. Given that both motors contribute to tape transport, relatively small and therefore inexpensive and compact motors can be used.

A tape drive in accordance with certain other embodiments of the present invention operates in a pull-drag mode in which the motor attached to the spool currently taking up tape drives the spool in the direction of tape transport, whereas the motor coupled to the other spool is driven in a reverse direction in order to tension the tape. In accordance with yet other embodiments of the present invention the tape drive motors may be arranged to operate in a push-pull mode for at least part of a printing cycle and a pull-drag mode for at least another part of the printing cycle.

The actual rotational direction of each spool will depend on the sense in which the tape is wound on each spool. If both spools are wound in the same sense then both spools will rotate in the same rotational direction to transport the tape. If the spools are wound in the opposite sense to one another, then the spools will rotate in opposite rotational directions to transport the tape. In any configuration, both spools rotate in the direction of tape transport. However, according to the operating mode of the supply spool motor, the direction in which it is driven may also be in the same direction as the supply spool (when the motor is assisting in driving the tape, by pushing the tape off the spool) or the supply spool motor may be driven in the opposite direction to that of the supply spool (when the motor is providing drag to the tape in order to tension the tape).

The tape drive may be incorporated in a transfer printer for transferring ink from a printer tape to a substrate, which is transported along a predetermined path adjacent to the printer. The tape drive may act as a printer tape drive mechanism for transporting ink ribbon between first and second tape spools, and the printer further comprising a printhead arranged to contact one side of the ribbon to press an opposite side of the ribbon into contact with a substrate on the predetermined path. There may also be provided a printhead drive mechanism for transporting the printhead along a track extending generally parallel to the predetermined substrate transport path (when the printer is operating in an intermittent printing mode) and for displacing the printhead into and out of contact with the tape. A controller may control the printer ink ribbon and printhead drive mechanisms, the controller being selectively programmable either to cause the ink ribbon to be transported relative to the predetermined substrate transport path with the printhead stationary and displaced into contact with the ink ribbon during printing, or to cause the printhead to be transported relative to the ink ribbon and the predetermined substrate transport path and to be displaced into contact with the ink ribbon during printing.

The drive mechanism may be bi-directional such that tape may be transported from a first spool to a second spool and from the second spool to the first. Typically, unused tape is provided in a roll of tape mounted on the supply spool. Used tape is taken up on a roll mounted on the take-up spool. However, as described above, in order to prevent gross ribbon wastage, after a printing operation the tape can be reversed such that unused portions of the tape may be used before being wound onto the take-up spool.

### BRIEF DESCRIPTION OF THE DRAWINGS

Embodiments of the present invention will now be described, by way of example, with reference to the accompanying drawings in which:

FIG. 1 is a schematic illustration of a printer tape drive system in accordance with an embodiment of the present invention;

FIGS. 2A and 2B are illustrations showing how a sensor in the tape drive of FIG. 1 monitors tape movement;

FIG. 3 is an illustration of an alternative sensor system; and

FIG. 4 is a schematic illustration showing the controller of FIG. 1 in further detail.

### DETAILED DESCRIPTION OF THE INVENTION

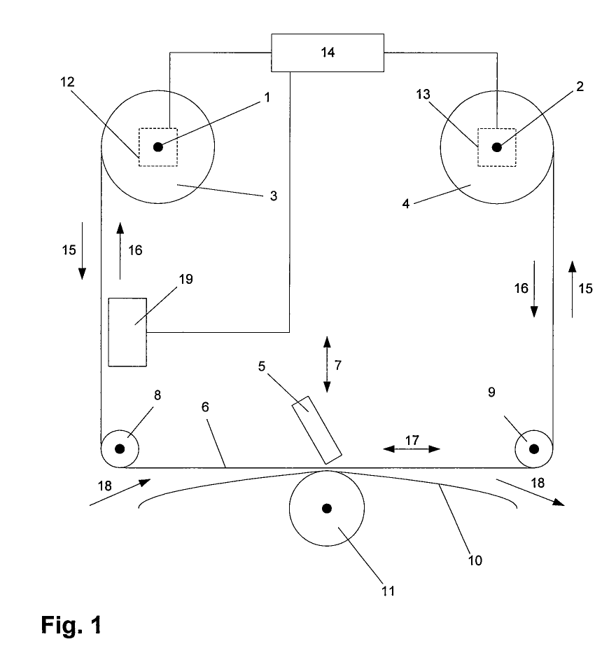

Referring to FIG. 1, this schematically illustrates a tape drive in accordance with the present invention suitable for use in a thermal transfer printer. First and second shafts 1, 2 support a supply spool 3 and a take-up spool 4 respectively. The supply spool 3 is initially wound with a roll of unused tape, and the take-up spool 4 initially does not carry any tape. As tape is used, used portions of the tape are transported from the supply spool 3 to the take-up spool 4. A displaceable printhead 5 is provided, displaceable relative to tape 6 in at least a first direction indicated by arrow 7. Tape 6 extends from the supply spool 3 around rollers 8, 9 to the take-up spool 4. The path followed by the tape 6 between the rollers 8 and 9 passes in front of the printhead 5. A substrate 10 upon which print is to be deposited is brought into contact with the tape 6 between rollers 8 and 9, the tape 6 being interposed between the printhead 5 and the substrate 10. The substrate 10 may be brought into contact with the tape 6 against a platen roller 11.

The supply shaft 1 is driven by a supply motor 12 and the take-up shaft 2 is driven by a take-up motor 13. The supply and take-up motors 12, 13 are illustrated in dashed outline, indicating that they are positioned behind the supply and take-up spools 3, 4. It will however be appreciated that in alternative embodiments of the invention, the spools are not directly driven by the motors. Instead the motor shafts may be operably connected to the respective spools by a belt drive or other similar drive mechanism. In either case, it can be seen that there is a fixed transmission ratio between a motor and its respective spool support.

A controller 14 controls the operation of motors 12, 13 as described in greater detail below. The supply and take-up motors 12, 13 are capable of driving the tape 6 in both directions. Tape movement may be defined as being in the print direction if the tape is moving from the supply spool 3 to the take-up spool 4, as indicated by arrows 15. When tape is moving from the take-up spool 4 to the supply spool 3, the tape may be considered to be moving in the tape reverse direction, as indicated by arrows 16.

When the printer is operating in continuous mode the printhead 5 will be moved into contact with the tape 6 when the tape 6 is moving in the print direction 15. Ink is transferred from the tape 6 to the substrate 10 by the action of the printhead 5. Tape movement may be reversed such that unused portions of the tape 6 are positioned adjacent to the printhead 5 before a subsequent printing operation is commenced.

In the configuration illustrated in FIG. 1, the spools 3, 4 are wound in the same sense as one another and thus rotate in the same rotational direction to transport the tape. Alternatively, the spools 3, 4 may be wound in the opposite sense to one another, and thus must rotate in opposite directions to transport the tape.

As described above, the printer schematically illustrated in FIG. 1 can be used for both continuous and intermittent printing applications. The controller 14 is selectively programmable to select either continuous or intermittent operation. In continuous applications, the substrate 10 will be moving continuously. During a printing cycle, the printhead 5 will be stationary but the tape will move so as to present fresh tape to the printhead 5 as the cycle progresses. In contrast, in intermittent applications, the substrate 10 is stationary during each printing cycle, the necessary relative movement between the substrate 10 and the printhead 5 being achieved by moving the printhead 5 parallel to the tape 6 and substrate 10 in the direction of arrow 17 during the printing cycle. In such a case, the roller 11 is replaced with a flat print platen (not shown) against which the printhead 5 presses the ribbon 6 and substrate 10. In both applications, it is necessary to be able to rapidly advance and return the tape 6 between printing cycles so as to present fresh tape to the printhead and to minimise tape wastage. Given the speed at which printing machines operate, and that fresh tape 6 should be present between the printhead 5 and substrate 10 during every printing cycle, it is necessary to be able to accelerate the tape 6 in both directions at a high rate and to accurately position the tape relative to the printhead. In the arrangement shown in FIG. 1 it is assumed that the substrate 10 will move only to the right as indicated by arrows 18. However, the apparatus can be readily adapted to print on a substrate travelling to the left (that is, in the opposite direction) in FIG. 1.

The printer shown in FIG. 1 further comprises a sensor 19 which is adapted to sense displacement of the tape 6 and provide a signal indicative of tape displacement to the controller 14. The sensor 19 can take any suitable form. For example, the sensor 19 may take the form of an optical sensor. Such an optical sensor may take the form of a charge coupled device (CCD). In general terms the sensor captures two images of the tape as it moves from the supply spool 3 to the take-up spool 4. By comparing the captured images, tape displacement can be determined as described below. There are a wide range of commercially available CCDs. Suitable CCDs are commonly used within an optical computer mouse, and thus may be referred to as optical mouse sensors.

An example of a suitable commercially available optical mouse sensor that may be used within a tape drive as the sensor 19 is the ADNS-3060, which is manufactured by Agilent Technologies. It will be appreciated that other similar sensors could also be used. The ADNS-3060 is an optical sensor that is typically used to detect high speed motion, for instance speeds of up to approximately 1 ms⁻¹, and accelerations of up to approximately 150 ms⁻². Such a mouse sensor operates by recording a series of images of the surface over which it is passed, typically up to 6400 images per second. The resolution of each image is up to 800 counts per inch (cpi) (20320 counts per cm).

The present inventors have realised that such an optical mouse sensor may be used to measure linear displacement of a tape. The available resolution of the ADNS-3080 is sufficient to detect surface flaws in a portion of the tape, such that displacement of tape can be detected as described below.

The ADNS-3060 measures changes in position by optically acquiring sequential surface images and mathematically determining the direction and magnitude of movement between consecutive frames. By recording a plurality of images over a known period of time, the change in position, speed and acceleration of the tape can be calculated.

The ADNS-3060 comprises an integral light source in the form of an LED together with a CCD for capturing images at a predetermined rate. An internal microprocessor is adapted to calculate relative motion between frames in first and second orthogonal directions, and provide the calculated relative motion at a serial interface. Data provided at the serial interface is provided to the controller 14.

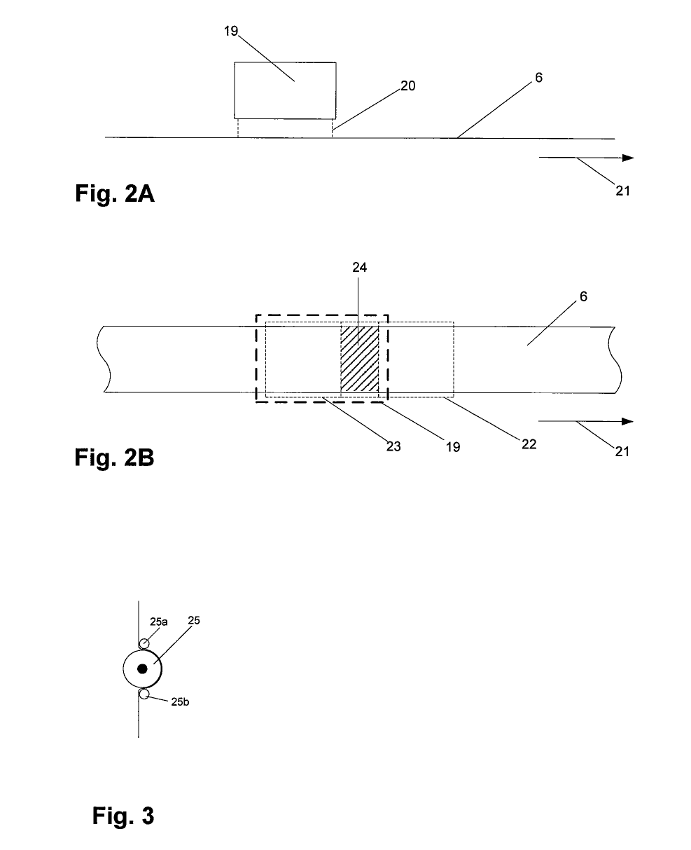

Referring now to FIG. 2A, this schematically illustrates in side view a portion of the tape 6 and the sensor 19 arranged to capture a series of images of the surface of the tape 6 over a period of time. The field of view of the optical sensor 19 is indicated by dashed lines 20. For the purpose of explaining the operation of the sensor 19, the tape 6 is considered only to be moving in a single direction, indicated by an arrow 21. It will however be appreciated that the tape may be travelling in either direction, and the optical sensor is able to detect motion in both directions.

FIG. 2B is a plan view of the same optical sensor arrangement of FIG. 2A. The optical sensor 19 is illustrated in dashed outline so as not to obscure the representation of the field of view of the sensor 19. FIG. 2 further illustrates a first image 22 captured by the sensor 19. The tape 6 has moved to the right (in the direction of arrow 21) since the first image 22 was captured. After a predetermined time interval, the tape 6 is now positioned relative to the optical sensor 19 as illustrated and a second image 23 is captured, corresponding to the current field of view of the sensor 19.

It can be seen that the first image 22 and the second image 23 include a common part of the tape 6 indicated by the hatched area 24. By comparison of variations in the surface texture of the tape 6 captured in the two images 22, 23 the area of overlap 24 between the two images can be detected. The position of the area of overlap 24 in each of the images 22, 23 can then be determined, allowing the amount by which the tape 6 has moved between the first image 22 and the second image 23 can be determined. It will be apparent that as long as consecutive images are recorded sufficiently frequently, such that they contain an area of overlap even when the tape 6 is travelling at its maximum velocity, then relative movement of the tape 6 between consecutive images will always be measurable. From knowledge of an elapsed time between capture of the two images, the velocity of the tape can be determined.

In an alternative embodiment of the invention, the sensor 19 configured to detect displacement of the tape 6 takes the form of a roller 25 as shown in FIG. 3. It can be seen that the tape is passed around a part of the roller 25, and around guide rollers 25a, 25b. The roller 25 is an idler roller. The roller 25 is provided with an anti-slip coating to prevent slippage occurring between the tape and the idler roller when the tape is moved. Thus when the tape is caused to move, movement of the tape causes the roller 25 to rotate. By knowing the outer diameter of the roller 25, and monitoring its rotation it will be appreciated that it is possible to determine displacement of the tape 6. Rotation of the roller 25 can be monitored in any convenient way. For example, the roller 25 may be provided with a magnetic disc having a north and south pole. Rotation of the roller can then be detected by an appropriate magnetic sensor. Alternatively, optical means can be used to monitor rotation of the roller 25. The use of a roller to monitor tape movement for a different purpose is described in GB 2,298,821, which is referred to above.

Referring back to FIG. 1, two suitable forms for the sensor 19 have been described above. It will however be appreciated that any suitable mechanism for determining linear displacement of the tape 6 may be used. In any event, a signal indicating tape displacement is provided by the sensor 19 to the controller 14. The signal received by the controller 14 is used to generate a control signal to be provided to at least one of the motors 12, 13.

In alternative embodiments of the invention instead of providing a displacement sensor, a velocity sensor is provided. Such a velocity sensor can be provided by an optical mouse sensor of the type described above. Alternatively, the configuration of FIG. 3 may be adapted to provide a velocity sensor by causing a magnet attached to the roller 25 to rotate adjacent to a coil, and monitoring the voltage across or the current running through the coil. The amplitude of the voltage or current will, in that case, provide an indication of the rotational speed of the roller 25 and consequently the speed of the tape 6.

In a first described embodiment of the invention, one of the motors 12, 13 is a torque-controlled motor. The torque-controlled motor is controlled using a control signal which is generated with reference to a signal received from the sensor 19 as is now described. A torque-controlled motor is a motor that is controlled by a demanded output torque. An example of a torque-controlled motor is a DC motor without encoder feedback, or a DC motor having an encoder, but in which the encoder signal is temporarily or permanently not used. Alternatively, coupling a stepper motor with an encoder and using the encoder output signal to generate a commutation signal that in turn drives the motor can provide a torque-controlled stepper motor. Varying the current that may be drawn by the motor can vary the torque provided by a torque-controlled motor of either sort.

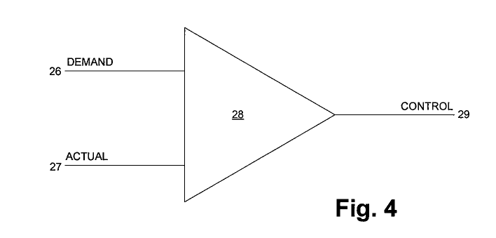

Part of the controller 14 is shown in further detail in FIG. 4. The controller processes a demanded tape displacement. This displacement is expressed in terms of a length of tape, although the length of tape may be encoded in any convenient way, for example as a voltage. The controller receives as input an actual tape displacement provided by the sensor 19. It can be seen that signals indicative of demanded tape displacement 26 and actual tape displacement 27 are input to a differential amplifier 28, which outputs a control signal 29. The control signal 29 is processed by an appropriate algorithm (for example a PID algorithm) to generate a signal to be provided to the torque-controlled motor.

The differential amplifier 28 determines the output control signal 29 by determining a difference between the demanded tape displacement 26 the actual tape displacement 27 received from the sensor, and using the determined difference to generate the output control signal 29, the output control signal 29 being generated so as to control the or each motor to minimise the difference between the demanded tape displacement 26 and the actual tape displacement 27.

The feedback signal from the sensor 19 is thus used by the controller 14 to adjust the drive signal to a torque-controlled motor, such that the torque controlled motor is provided with a control signal meaning that it is driven until the demanded tape displacement has been achieved. This effectively means that the torque-controlled motor functions in a closed loop manner providing a position-controlled motor.

A position-controlled motor comprises a motor controlled by a demanded output position. That is, the output position may be varied on demand, or the output rotational velocity may be varied by control of the speed at which demanded output rotary position changes. An example of a position-controlled motor is a stepper motor, which is an open loop position-controlled motor.

In an alternative embodiment of the present invention, the controller 14 uses signals indicative of demanded and actual tape displacement to control an open loop position-controlled motor, such as a stepper motor, thus operating the open loop position-controlled motor as a closed loop position-controlled motor.

In general terms, the tape drive shown in FIG. 1 can be operated using any combination of torque-controlled and position-controlled motors. For example, the take up motor 13 may be a torque-controlled motor. In such a case when tape is moving in the print direction 15, the torque-controlled take up motor 13 is energised in the direction of tape transport so as to cause the tape to move. However, when tape is moved in the tape-reverse direction 16, the torque-controlled take up motor 13 is energised so as to oppose tape movement, and thereby apply tension to the tape. Therefore when travelling in the tape-reverse direction 16 the supply motor 12 (which is coupled to the spool 3 on which tape is being wound) must apply a force to pull tape onto the spool 3 and to overcome the force applied by the torque-controlled motor 13. In such a case the supply motor 12 can be a position-controlled or torque-controlled motor. Where the supply motor 12 is a position-controlled motor, when the tape is moving in the print direction 15 the position-controlled motor is energised in the direction of tape transport.

It can thus be seen that a tape drive in accordance with embodiments of the present invention may be operated in any required mode, for instance push-pull or pull-drag. The sensor 19 can be used to control either the supply motor 12, the take-up motor 13, or both. Furthermore, the sensor 19 may be used to separately control each motor during different portions of a printing cycle. For instance, the tape drive may comprise two torque controlled motors. The sensor 19 may be used to provide a tape position feedback signal to whichever motor is driving a spool currently taking-up tape (such that the tape drive operates in pull-drag mode in both the print direction and the tape reverse direction). Alternatively, the sensor 19 may be used to provide a feedback signal to whichever motor is driving a spool currently supplying tape (such that the tape drive operates in push-pull mode in both the print direction and the tape reverse direction). It will be appreciated that the sensor 19 can be used to drive a wide variety of motor types in any convenient way.

For a tape drive comprising two torque-controlled motors, only one of which is controlled using the linear position sensor signal for position control, tension within the tape may be set by torque control of the other motor.

In general terms, the tape drive described with reference to FIG. 1 is configured to carry out a plurality of tape movement operations, each movement operation being associated with a particular print operation. Each tape movement operation will have one or more demanded tape displacements which are provided to the controller 14. Where more than one tape displacement is provided to the controller 14, by providing suitable displacements at predetermined time intervals, a desired acceleration profile can be achieved. Thus, the or each tape displacement provided to the controller 14 is preferably determined with reference to predefined data defining tape movement requirements.

In accordance with a further embodiment of the present invention, more than one linear position sensor is used, either for redundancy or to separately control each motor. That is, the controller may receive two signals indicative of actual tape displacement. These signals can either be used to generate two respective control signals, one for each of the supply motor 12 and the take-up motor 13, or can alternatively be used in combination for control of one or both of the motors.

If the rotation of a spool of tape is monitored to determine an angle of rotation through which the spool has turned, then by knowing the amount of tape that is wound or unwound from the spool, using the sensor 19, the current diameter of the spool can be calculated.

Alternatively, rotation of the roller 25 (FIG. 3) may be used to determine spool diameter if at least one of the supply motor 12 and take-up motor 13 is a position-controlled motor. By detecting rotation of the roller 25 of known diameter and knowing an angle through which the position-controlled motor has turned, the diameter of a spool of tape associated with the position-controlled motor can be determined.

However, if the supply motor 12 is a position-controlled motor, by knowing a linear displacement (provided by the sensor 19) and knowing a rotation of the supply motor 12 providing that displacement, the diameter of the supply spool 3 can be determined. Although it is sometimes preferred to determine spool diameters, it should be noted that in a tape drive employing the sensor 19, spool diameter determination is not essential.

In accordance with certain embodiments of the present invention tape tension is monitored in order to provide a feedback signal allowing the drive signal provided to one or both motors to be varied in order to control the actual tension in the tape. This is different to and more accurate than only varying the drive signal in accordance with a demanded tape tension, which may differ from the actual tape tension due to factors external to the motors, for instance the tape stretching over time. The monitoring of tape tension is particularly useful in tape drives using position-controlled motors which do not set tension in the tape.

Where appropriate, any suitable method of measuring the tension of a tape may be used, including directly monitoring the tension through the use of a component that contacts the tape and indirect tension monitoring. Direct tension monitoring includes, for example, a resiliently biased roller or dancing arm that is in contact with the tape, arranged such that a change in tape tension causes the roller or dancing arm to move position, the change in position being detectable using, for example a linear displacement sensor. Alternatively, tape may be passed around a roller which bears against a load cell. Tension in the tape affects the force applied to the load cell, such that the output of the load cell provides an indication of tape tension.

Indirect tension monitoring includes methods in which the work done by a motor is monitored, and a measure of tension is derived from that work done. Where the tape-drive includes two position-controlled motors such as stepper motors, monitoring the power supplied to the motors allows a measure of tape tension to be determined. This technique is described in further detail in our earlier UK Patent No. GB 2,369,602.

As noted above, tape drives in accordance with embodiments of the present invention may be used in thermal transfer printers of the type described above. Tape drives in accordance with embodiments of the present invention may be advantageously used in a thermal transfer over printer, such as may be used within the packaging industry, for instance for printing further information such as dates and bar codes over the top of pre-printed packaging (such as food bags).

Additionally, tape drives in accordance with embodiments of the present invention may be used in other applications, and provide similar advantages to those evident in thermal transfer printers, for instance fast and accurate tape acceleration, deceleration, speed and positional accuracy.

An alternative application where such tape drives may be applied is in labelling machines, which are adapted to apply labels detached from a continuous tape (alternatively referred to as a label web). Tape drives in accordance with embodiments of the present invention are suitable for use in labelling machines in which a label carrying web is mounted on a supply. Labels are removed from the web, and the web is driven onto a take-up spool.

In general, tape drives in accordance with embodiments of the present invention may be used in any application where there is a requirement to transport any form of tape, web or other continuous material from a first spool to a second spool.

Reference has been made in the foregoing description to DC motors. In the present context the term “DC motor” is to be interpreted broadly as including any form of motor that can be driven to provide an output torque, such as a brushless DC motor, a brushed DC motor, an induction motor or an AC motor. A brushless DC motor comprises any form of electronically commutated motor with integral commutation sensor. Similarly, the term stepper motor is to be interpreted broadly as including any form of motor that can be driven by a pulsed drive signal, each pulse indicating a further required change of rotary position.

Further modifications and applications of the present invention will be readily apparent to the appropriately skilled person from the teaching herein, without departing from the scope of the appended claims.

What is claimed is:

1. A tape drive comprising first and second motors, two tape spool supports on which spools of tape may be mounted, each spool being drivable by a respective one of said motors, a sensor for sensing tape motion between the spools, and a controller adapted to:
receive a first signal indicating demanded tape motion,
provide a first control signal to at least one of the motors, the first control signal being based upon said demanded tape motion and being configured to cause tape to be transported between spools mounted on the spool supports;
receive a second signal from said sensor indicating actual tape motion in response to said first control signal; and
provide a second control signal to at least one of the motors, the second control signal being based upon said first and second signals.

2. A tape drive according to claim 1, wherein said sensor is configured to sense tape displacement.

3. A tape drive according to claim 1, wherein said sensor is configured to sense tape velocity.

4. A tape drive according to claim 1, wherein said sensor is a non-contact sensor.

5. A tape drive according to claim 1, wherein said first control signal is further based upon an initial signal received from said sensor.

6. A tape drive according to claim 1, wherein the tape drive is configured to carry out a plurality of tape movement operations, each operation having at least one associated demanded tape motion and wherein for each operation the controller is adapted to receive a plurality of second signals, each second signal indicative of tape motion during that operation.

7. A tape drive according to claim 1, wherein at least one of the first and second motors is a torque-controlled motor.

8. A tape drive according to claim 1, wherein at least one of the first and second motors is a position-controlled motor.

9. A tape drive according to claim 8, wherein the or each position-controlled motor is a stepper motor.

10. A tape drive according to claim 1, wherein said controller is adapted to provide said control signals to said first motor and said second motor.

11. A tape drive according to claim 1, further comprising a second sensor arranged to provide a third signal to the controller indicative of actual tape motion.

12. A tape drive according to claim 11, wherein the controller is configured to use the third signal to generate a third control signal and to provide said third control signal to at least one of said motors.

13. A tape drive according to claim 1, wherein the controller is arranged to control the motors to transport tape in both directions between the spools.

14. A tape drive according to claim 1, wherein each sensor comprises an optical sensor arranged to capture and compare images of the tape at a position between the spools at predetermined intervals and to detect movement of the tape between the spools.

15. A tape drive according to claim 1, wherein each sensor comprises a roller and means for sensing rotation of the roller, the roller being arranged to contact the tape between the spools such that linear movement of the tape causes the roller to rotate.

16. A tape drive according to claim 1, wherein the controller is operative to monitor tension in the tape being transported between the spools.

17. A tape drive according to claim 16, wherein the controller is operative to control the motors to maintain tension within predetermined limits.

18. A tape drive according to claim 1, wherein each spool support is coupled to a respective motor by means of a drive coupling providing at least one fixed transmission ratio.

19. A tape drive according to claim 18, wherein the drive coupling comprises a drive belt.

20. A tape drive according to claim 1, wherein each spool support has a respective first axis of rotation, each motor has a shaft with a respective second axis of rotation, and the respective first and second axes are co axial.

21. A tape drive according to claim 18, wherein each spool support has a respective spool shaft, each motor has a respective motor shaft and respective drive couplings interconnect a respective spool shaft to a respective motor shaft.

22. A tape drive according to claim 1 incorporated in a thermal transfer printer.

23. A tape drive according to claim 22, wherein the printer is configured to transfer ink from a printer ribbon to a substrate which is transported along a predetermined path adjacent to the printer, the tape drive acting as a printer ribbon drive mechanism for transporting ribbon between first and second ribbon spools, and the printer further comprising a printhead arranged to contact one side of the ribbon to press an opposite side of the ribbon into contact with a substrate on the predetermined path.

24. A tape drive according to claim 23, wherein the printer further comprises a printhead drive mechanism for transporting the printhead along a track extending generally parallel to the predetermined substrate transport path and for displacing the printhead into and out of contact with the ribbon, and a printer controller controlling the printer ribbon and printhead drive mechanisms.

25. A tape drive according to claim 24, wherein the printer controller is selectively programmable either to cause the ribbon to be transported relative to the predetermined substrate transport path with the printhead stationary and displaced into contact with the ribbon during printing, or to cause the printhead to be transported relative to the ribbon and the predetermined substrate transport path and to be displaced into contact with the ribbon during printing.

26. A tape drive according to claim 22, wherein the printer is a thermal transfer over printer.

27. A method for controlling a tape drive comprising first and second motors, two tape spool supports on which spools of tape may be mounted, each spool being drivable by a respective one of said motors, a sensor for sensing tape motion between the spools, and a controller, wherein the controller:
receives a first signal indicating demanded tape motion,
provides a first control signal to at least one of the motors, the first control signal being based upon said demanded tape motion and being configured to cause tape to be transported between spools mounted on the spool supports;
receives a second signal from said sensor indicating actual tape motion in response to said first control signal; and
provides a second control signal to at least one of the motors based upon said first and second signals.

28. A tape drive comprising first and second motors, the first motor being a torque-controlled motor, two tape spool supports on which spools of tape may be mounted, each spool being drivable by a respective one of said motors, a controller for controlling the energization of the motors such that the tape may be transported in at least one direction between spools mounted on the spool supports, and a sensor arranged to provide a position signal to the controller indicative of movement of the tape between the spools, wherein the controller is operative to receive an input signal indicative of a demanded tape displacement and to use the position signal to provide a control signal to the first motor to control the first motor based on the demanded tape displacement.
